(19) United States
(12) Patent Application Publication
(10) Pub. No.: US 2026/0358545 A1
(43) Pub. Date: Nov. 12, 2026

(54) FRONT LIGHT SOURCE, DISPLAY ASSEMBLY AND DISPLAY DEVICE

(71) Applicants: Beijing BOE Display Technology Co., Ltd., Beijing (CN); BOE Technology Group Co., Ltd., Beijing (CN); Beijing BOE Technology Development Co., Ltd., Beijing (CN)

(72) Inventors: Jingjun DU, Beijing (CN); Xiuyun CHEN, Beijing (CN); Peng ZHONG, Beijing (CN); Tingxiu HOU, Beijing (CN); Yaxin SUN, Beijing (CN); Qianqian HAO, Beijing (CN); Ziyan ZHANG, Beijing (CN); Cunqing GUO, Beijing (CN); Weibo LI, Beijing (CN)

(21) Appl. No.: 19/487,985

(22) PCT Filed: Apr. 17, 2024
(86) PCT No.: PCT/CN2024/088298

§ 371 Date: Nov. 25, 2025

(30) Foreign Application Priority Data
May 31, 2023 (CN) 202310633366.1

(51) Int. Cl. F21V 8/00; G02F 1/1335; G02F 1/13357

(52) U.S. Cl. CPC G02B 6/0036; G02F 1/133615; G02F 1/133616

(57) ABSTRACT

A front light source includes a light guide layer, a light source, and a microstructure layer. The light guide layer has first and second surfaces opposite to each other, and a lateral surface connecting the first surface with the second surface. The light source is positioned on a side of the lateral surface, and the microstructure layer is positioned on a side of the second surface.

The microstructure layer includes first microstructures and second microstructures. Each first microstructure has a first total internal reflection surface and each second microstructure has a second total internal reflection surface, for totally internally reflecting light. An angle between the first total internal reflection surface and a horizontal direction is different from an angle between the second total internal reflection surface and the horizontal direction, to cause light rays with different incident angles to be reflected toward the first surface and extracted out.

### CROSS-REFERENCE TO RELATED APPLICATIONS

This is a National Phase Application filed under 35 U.S.C. 371 as a national stage of PCT/CN2024/088298 filed on Apr. 17, 2024, an application claiming priority to Chinese patent application No. 202310633366.1, filed on May 31, 2023, the entire content of each of which is incorporated herein by reference.

### TECHNICAL FIELD

The present disclosure relates to the field of display technology, and in particular, to a front light source, a display assembly, and a display device.

### BACKGROUND

A reflective liquid crystal display panel realizes display by reflecting ambient light by utilizing a metal layer on a display substrate, without including a backlight source, has the advantages of low power consumption, light weight, thinness and the like, and is widely applied to outdoor watches, electronic price tags, readers, bus stop boards, and the like. However, when the ambient light is weak or the environment is dark, a brightness of the reflected ambient light is reduced, and the reflective liquid crystal display panel has a problem of poor display effect or display failure. Thus, it is necessary to attach a front light source onto the reflective liquid crystal display panel to enhance the display effect of the reflective liquid crystal display panel.

At present, the front light source of the reflective liquid crystal display panel needs to emit light downward as much as possible, and a microstructure layer needs to be arranged on a light guide layer, where a lateral surface of a microstructure can reflect the light in the light guide layer downward. However, the current microstructure has a relatively constant design angle, but a total internal reflection light angle of light propagating in the light guide layer is changed significantly. Thus, the constant microstructure is difficult to fully utilize all light, so that the light efficiency is low, a display brightness and a contrast of the reflective display panel each are severely limited, and the display effect of the reflective display panel is deteriorated.

### SUMMARY

To solve at least one of the technical problems in the prior art, the present disclosure provides a front light source, a display assembly, and a display device.

In a first aspect, embodiments of the present disclosure provide a front light source, which includes a light guide layer, a light source, and a microstructure layer, wherein the light guide layer has a first surface and a second surface which are opposite to each other, and a lateral surface connecting the first surface with the second surface, the light source is positioned on a side of the lateral surface of the light guide layer, and the microstructure layer is positioned on a side of the second surface of the light guide layer; and
the microstructure layer includes a plurality of first microstructures and a plurality of second microstructures, each of the plurality of first microstructures has a first total internal reflection surface for totally internally reflecting light, each of the plurality of second microstructures has a second total internal reflection surface for totally internally reflecting the light, and an angle between the first total internal reflection surface and a horizontal direction is different from an angle between the second total internal reflection surface and the horizontal direction, to cause light rays with different incident angles to be reflected toward the first surface of the light guide layer and extracted out.

Optionally, in the front light source,

θ=arcsin(sin 90°×n₁/n₀);

β₀=(90°−α₀+α₁)/2−θ;

β₁=α₁−(β₀−α₀);

ε₁=90°−θ−β₀;

λ₀=(90°−β₀+β₂)/2−−θ+β₀;

λ₁=β₂−(λ₀-31 β₀);

ε₂=(90°−β₀+β₂)/2−β₂;
where θ is a critical angle at which the light undergoes total internal reflection in the microstructure layer, n₁is a refractive index of the microstructure layer, and n₀ is a refractive index of a structure, which is located on a side of the microstructure layer distal to the light guide layer and is in contact with the microstructure layer;
α₀ is an angle between a first boundary incident light ray in each first microstructure and the horizontal direction, α₁ is an angle between a first boundary outgoing light ray in each first microstructure and a vertical direction, β₀ is each of an angle between a second boundary incident light ray in each first microstructure and the horizontal direction and an angle between a first boundary incident light ray in each second microstructure and the horizontal direction, β₁ is an angle between a second boundary outgoing light ray in each first microstructure and the vertical direction, and ε₁ is an angle between the first total internal reflection surface of each first microstructure and the horizontal direction; and
β₂ is an angle between a first boundary outgoing light ray in each second microstructure and the vertical direction, λ₀ is an angle between a second boundary incident light ray in each second microstructure and the horizontal direction, λ₁ is an angle between a second boundary outgoing light ray in each second microstructure and the vertical direction, and ε₂ is an angle between the second total internal reflection surface of each second microstructure and the horizontal direction.

Optionally, each first microstructure further has a first inclined surface connected to the first total internal reflection surface, each second microstructure further has a second inclined surface connected to the second total internal reflection surface, and each of an angle between the first inclined surface and the vertical direction and an angle between the second inclined surface and the vertical direction is less than the critical angle at which the light undergoes total internal reflection.

Optionally, each second microstructure is located on a side of a respective first microstructure distal to the second surface of the light guide layer, the first total internal reflection surface is connected to the second total internal reflection surface, and the first inclined surface is connected to the second inclined surface.

Optionally, each second microstructure is located on a side of a respective first microstructure proximal to the second surface of the light guide layer, the first total internal reflection surface is connected to the second total internal reflection surface, and the first inclined surface is connected to the second inclined surface.

Optionally, each first microstructure and a respective second microstructure have a one-piece structure.

Optionally, the first microstructures and the second microstructures are alternately arranged to be spaced apart from each other along a direction away from the light source.

Optionally, a distance between any one first microstructure and the second microstructure adjacent to the any one first microstructure is gradually decreased in the direction away from the light source.

Optionally, the microstructure layer further includes a third microstructure located between the light source and the first and second microstructures, the third microstructure has a third total internal reflection surface for totally internally reflecting the light, and the third total internal reflection surface is arranged opposite to each of the first total internal reflection surface and the second total internal reflection surface, so as to reflect the light rays toward the first total internal reflection surface and the second total internal reflection surface.

Optionally, in the front light source, ξ₀=θ;

ξ₁=ξ₀;

ε₃=(90°−ξ₁+ξ₀)/2−ξ₀;

λ₂=ξ₁−(90°−ξ₀−λ₀);
where ξ₀ is an angle between a second boundary incident light ray and the vertical direction, ξ₁ is an angle between a second boundary outgoing light ray and the horizontal direction, and ξ₃ is an angle between the third total internal reflection surface of the third microstructure and the horizontal direction.

Optionally, the third microstructure further has a third inclined surface connected to the third total internal reflection surface, and an angle between the third inclined surface and the vertical direction is less than the critical angle at which the light undergoes total internal reflection.

Optionally, each of the first microstructures, the second microstructures, and the third microstructure is a groove recessed toward the first surface of the light guide layer.

Optionally, the microstructure layer further includes a transparent material filled in the first microstructures, the second microstructures, and the third microstructure; and
a refractive index of the transparent material is less than a refractive index of the light guide layer.

Optionally, the microstructure layer further includes a support structure for supporting the first microstructures, the second microstructures, and the third microstructure; and
the support structure is located on the side of the second surface of the light guide layer, and a refractive index of the support structure is the same as a refractive index of the light guide layer.

Optionally, the first microstructures, the second microstructures, and the third microstructure are formed on the second surface of the light guide layer.

In a second aspect, embodiments of the present disclosure provide a display assembly, which includes the front light source according to any one of the foregoing embodiments of the present disclosure.

Optionally, the display assembly further includes a polarizer, a display panel, a reflective layer, and a scatterer layer;
wherein the display panel is positioned on a side of the first surface of the light guide layer;
the reflective layer is positioned on a side of the display panel distal to the light guide layer;
the polarizer is positioned between the display panel and the light guide layer; and
the scatterer layer is positioned on a side of the microstructure layer distal to the light guide layer.

In a third aspect, embodiments of the present disclosure provide a display device, which includes the display assembly according to any one of the foregoing embodiments of the present disclosure.

### BRIEF DESCRIPTION OF THE DRAWINGS

FIG. 1 is a schematic diagram illustrating a structure of an exemplary front light source.

FIG. 2 is a schematic diagram illustrating a distribution of light emitted from a light source.

FIG. 3 is a schematic diagram illustrating a structure of a front light source according to an embodiment of the present disclosure.

FIG. 4 is a schematic diagram illustrating light paths of a first microstructure of a front light source according to an embodiment of the present disclosure.

FIG. 5 is a schematic diagram illustrating light paths of a second microstructure of a front light source according to an embodiment of the present disclosure.

FIG. 6 is a schematic diagram illustrating a layout of a first microstructure and a second microstructure of the front light source shown in FIG. 3.

FIG. 7 is a schematic diagram illustrating a structure of another front light source according to an embodiment of the present disclosure.

FIG. 8 is a schematic diagram illustrating a layout of a first microstructure and a second microstructure of the front light source shown in FIG. 7.

FIG. 9 is a schematic diagram illustrating a structure of another front light source according to an embodiment of the present disclosure.

FIG. 10 is a schematic diagram illustrating light paths of a third microstructure of a front light source according to an embodiment of the present disclosure.

FIG. 11 is a schematic diagram illustrating a structure of another front light source according to an embodiment of the present disclosure.

FIG. 12 is a schematic diagram illustrating a structure of a display assembly according to an embodiment of the present disclosure.

### DETAILED DESCRIPTION OF EMBODIMENTS

To make one of ordinary in the art better understand technical solutions of the present disclosure, the present disclosure will be further described in detail below with reference to the accompanying drawings and exemplary embodiments.

Unless defined otherwise, technical or scientific terms used herein shall have the ordinary meaning as understood by one of ordinary skill in the art to which the present disclosure belongs. The use of “first”, “second”, and the like in the present disclosure is not intended to indicate any order, quantity, or importance, but rather is to distinguish one element from another. Similarly, the use of the term “a”, “an”, “the”, or the like does not denote a limitation of quantity, but rather denotes the presence of at least one element. The term “comprising”, “including”, or the like, means that the element or item preceding the term contains the element or item listed after the term and its equivalent, but does not exclude the presence of other elements or items. The term “connected”, “coupled”, or the like is not limited to physical or mechanical connections, but may include electrical connections, whether direct or indirect. The terms “upper”, “lower”, “left”, “right”, and the like are used only for indicating relative positional relationships, and when the absolute position of an object being described is changed, the relative positional relationships may also be changed accordingly.

FIG. 1 is a schematic diagram illustrating a structure of an exemplary front light. As shown in FIG. 1, the front light source includes a light guide layer 101, a light source 102, and a microstructure layer 103. The light guide layer 101 has a first surface 101a and a second surface 101b which are opposite to each other, and a lateral surface 101c connecting the first surface 101a with the second surface 101b. The light source 102 is located on a side of the lateral surface 101c of the light guide layer 101. The microstructure layer 103 is located on a side of the second surface 101b of the light guide layer 101. The microstructure layer 103 includes a plurality of microstructures 103a uniformly arranged, and each of the plurality of microstructures 103a has a total internal reflection surface 103a′ that totally internally reflects light.

The lateral surface 101c of the light guide layer 101 may be a light incident surface, and the light source 102 is disposed on a side of the light incident surface of the light guide layer 101. Light emitted from the light source 102 may enter into the lateral surface of the light guide layer 101, and be totally internally reflected between the first surface 101a and the second surface 101b for light transmission. The microstructure layer 103 is provided with the plurality of uniformly arranged microstructures 103a, each of which has the total internal reflection surface 103a′ for totally internally reflecting light. The light reflected by total internal reflection surfaces 103a′ is emitted downward as much as possible, and a light output angle is collimated to be less than 25 degrees as much as possible, so that the light can be extracted out and applied to a total internal reflective liquid crystal display panel.

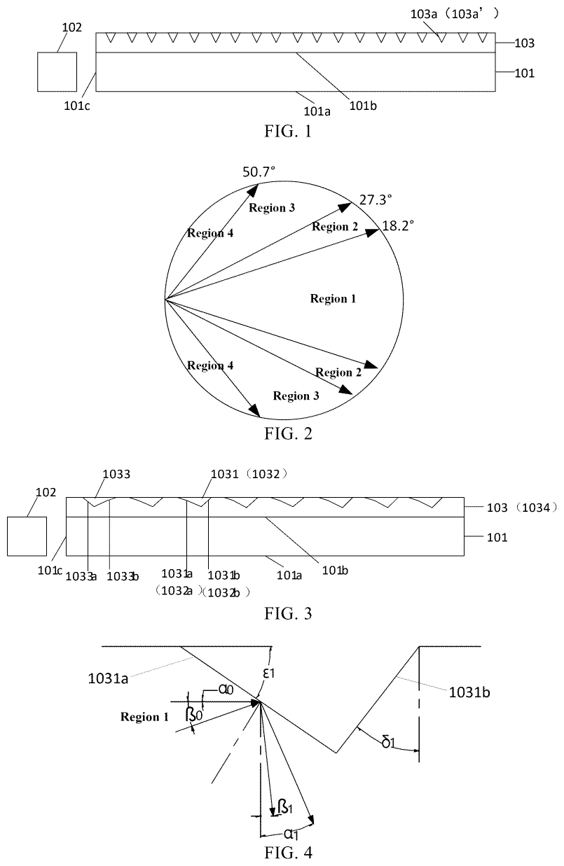

FIG. 2 is a schematic diagram illustrating a distribution of the light emitted from the light source. As shown in FIG. 2, the light emitted from the light source 102 has a Lambertian distribution, where the arrows indicate propagation directions of the light, and lengths of the arrows indicate proportions of the light in the directions. It can be seen that the proportions are different in different directions.

At present, a design angle (e.g., an angle between the total internal reflection surface 103a′ and the horizontal direction) of each of the microstructures 103a of the microstructure layer 103 is relatively constant, and the microstructures 103a in each region are uniformly arranged. However, total internal reflection angles of light rays in the light guide layer 101 are changed significantly. Thus, it is difficult to fully utilize all the light rays by using the microstructures 103a with the constant angle. For example, in practical applications, the total internal reflection surfaces 103a′ of the microstructures 103a can only totally internally reflect the light rays in region 1, and the light rays in other regions cannot be effectively utilized, causing the light efficiency to be low. Meanwhile, in a case where an angle of a propagation direction of a light ray close to the light source 102 is smaller than a total internal reflection angle, the light ray cannot be totally internally reflected in the light guide layer 101 and directly exits from the light guide layer 101, causing the light efficiency to be further low. As a result, when the resultant light is applied to a reflective liquid crystal display panel, the brightness and the contrast of display are deteriorated, which is not beneficial to improving the display effect, thereby deteriorating a use experience of a user.

To solve at least one of the above technical problems, embodiments of the present disclosure provide a front light source, a display assembly, and a display device. The front light source, the display assembly, and the display device provided by the embodiments of the present disclosure will be further described in detail below with reference to the accompanying drawings and exemplary embodiments.

In a first aspect, an embodiment of the present disclosure provides a front light source, and FIG. 3 is a schematic diagram illustrating a structure of the front light source provided by the present embodiment. As shown in FIG. 3, the front light source includes a light guide layer 101, a light source 102, and a microstructure layer 103. The light guide layer 101 has a first surface 101a and a second surface 101b which are opposite to each other, and a lateral surface 101c connecting the first surface 101a with the second surface 101b. The light source 102 is located on a side of the lateral surface 101c of the light guide layer 101. The microstructure layer 103 is located on a side of the second surface 101b of the light guide layer 101. The microstructure layer 103 includes a plurality of first microstructures 1031 and a plurality of second microstructures 1032. Each of the plurality of first microstructures 1031 has a first total internal reflection surface 1031a for totally internally reflecting light, and each of the plurality of second microstructures 1032 has a second total internal reflection surface 1032a for totally internally reflecting light. An angle ε₁ between the first total internal reflection surface 1031a and the horizontal direction is different from an angle ε₂ between the second total internal reflection surface 1032a and the horizontal direction, so that light (or light rays) with different incident angles is(are) reflected toward the first surface 101a of the light guide layer 101 and extracted out.

The lateral surface 101c of the light guide layer 101 may be a light incident surface. The light source 102 is disposed on a side of the light incident surface of the light guide layer 101, and light emitted from the light source 102 may enter into the lateral surface of the light guide layer 101, and be totally internally reflected between the first surface 101a and the second surface 101b for light transmission. The microstructure layer 103 is provided with the plurality of first microstructures 1031 and the plurality of second microstructures 1032. Each of the first microstructures 1031 has the first total internal reflection surface 1031a for totally internally reflecting light, and each of the second microstructures 1032 has the second total internal reflection surface 1032a for totally internally reflecting light. According to the schematic diagram of the light having the Lambertian distribution as shown in FIG. 2, the angle ε₁ between the first total internal reflection surface 1031a and the horizontal direction and the angle ε₂ between the second total internal reflection surface 1032a and the horizontal direction may be set to be different angles, so that the first total internal reflection surface 1031a can totally internally reflect light rays in region 1, and the second total internal reflection surface 1032a can totally internally reflect light rays outside region 1 (e.g., light rays in region 2), so that more light rays are reflected to the first surface 101a of the light guide layer 101 and extracted out.

In the front light source provided by the present embodiment, a first microstructure 1031 and a second microstructure 1032, which have different design angles, are provided in the microstructure layer 103, so that the first total internal reflection surface 1031a can totally internally reflect the light rays in region 1, and the second total internal reflection surface 1032a can totally internally reflect the light rays outside region 1 (e.g., the light rays in region 2), so that more light rays are reflected to the first surface 101a of the light guide layer 101 and extracted out. As such, the light utilization rate can be improved, and when the extracted light is applied to a reflective liquid crystal display panel, the brightness and the contrast of display can be improved, thereby improving the display effect and the use experience of a user.

FIG. 4 is a schematic diagram illustrating light paths of each first microstructure of the front light source according to the present embodiment, and FIG. 5 is a schematic diagram illustrating light paths of each second microstructure of the front light source according to the present embodiment. The light paths of each first microstructure and each second microstructure will be described in detail below with reference to FIG. 4 and FIG. 5.

The light guide layer 101 and the microstructure layer 103 may both be made of polycarbonate (PC), and have a same refractive index of 1.58. In a case where the horizontal direction to the right represents 0° and the vertical direction upward represents 90°, a distribution of the light rays in each angle range is as follows: region 1 for the light rays ranges from 0° to 18.2°, and a proportion of the light rays in this region is 39.1%; region 2 for the light rays ranges from 18.2° to 27.3°, and a proportion of the light rays in this region is 17.2%; region 3 for the light rays ranges from 27.3° to 50.7°, and a proportion of the light rays in this region is 31.3%; region 4 for the light rays ranges from 50.7° to 90°, and a proportion of the light rays in this region is 12.5%.

The refractive index of the microstructure layer 103 is n₀, a refractive index of a structure on a side of the microstructure layer 103 distal to the light guide layer 101 and in contact with the microstructure layer is n₁. To ensure total internal reflection of light in the microstructure layer 103 and the light guide layer 101, there should be n₀>n₁, and a critical angle of total internal reflection of light in the microstructure layer 103 is θ=arcsin(sin 90°×n₁/n₀). In a case where the refractive index of the microstructure layer 103 is 1.58 that is a refractive index of a PC material, and the refractive index of the structure on the side of the microstructure layer 103 distal to the light guide layer 101 and in contact with the microstructure layer is 1 that is a refractive index of the air, θ=39.3°. In a case where the structure on the side of the microstructure layer 103 distal to the light guide layer 101 and in contact with the microstructure layer is another layer, for example, a filling layer filled in the microstructure layer 103, a material of the filling layer may be a material having a refractive index less than the refractive index of the microstructure layer 103, so as to ensure that the light (or light rays) can be totally internally reflected on the surface of the microstructure layer 103, and in this case, the critical angle θ of total internal reflection may be another angle corresponding to the filling layer, and may be specifically calculated according to the formula of the critical angle of total internal reflection as described above, which will not be described in detail here. Each of the first microstructures 1031 and second microstructures 1032 may be a groove recessed toward the first surface 101a of the light guide layer 101, and a cross section of the groove may be a triangle, a trapezoid, or the like.

As shown in FIG. 4, in each first microstructure 1031, an angle between a first boundary incident light ray and the horizontal direction is α₀, where α₀=0°, and an angle between a first boundary outgoing light ray and the vertical direction is α₁, where α₁=25°; an angle between a second boundary incident light ray and the horizontal direction is β₀, and an angle between a second boundary outgoing light ray and the vertical direction is β₁, where β₀=(90°−α₀+α₁)/2−θ, calculation according to that the refractive index of the microstructure layer 103 is 1.58 and the refractive index of the upper air is 1 results in β₀=18.2°, β₁=α₁−(β₀−α₀), and calculation according to that the refractive index of the microstructure layer 103 is 1.58 and the refractive index of the upper air is 1 results in β₁=6.8°. The angle between the first total internal reflection surface 1031a of each first microstructure 1031 and the horizontal direction is ε₁, and ε₁=90°−θ−β₀. Calculation according to that the refractive index of the microstructure layer 103 is 1.58 and the refractive index of the upper air is 1 results in ε₁=32.5°.

As shown in FIG. 5, in each second microstructure 1032, an angle between a first boundary incident light and the horizontal direction is Bo, and an angle between the first boundary outgoing light and the vertical direction is β₂; according to the foregoing section it can be derived that β₀=(90°−α₀+α₁)/2−θ, and calculation results in β₂=25°. According to the foregoing section, calculation according to that the refractive index of the microstructure layer 103 is 1.58 and the refractive index of the upper air is 1 results in β₀=18.2°. An angle between a second boundary incident light ray and the horizontal direction is λ₀, and an angle between a second boundary outgoing light ray and the vertical direction is λ₁; where λ₀=(90°−β₀+β₂)/2−θ+β₀, calculation according to that the refractive index of the microstructure layer is 1.58 and the refractive index of the upper air is 1 results in λ₀=27.30; λ₁=β₂−(λ₀−β₀), and calculation according to that the refractive index of the microstructure layer 103 is 1.58 and the refractive index of the upper air is 1 results in λ₁=15.9°. The angle between the second total internal reflection surface 1032a of each second microstructure 1032 and the horizontal direction is ε₂, where ε₂=(90°−β₀+β₂)/2−β₂, and calculation according to that the refractive index of the microstructure layer 103 is 1.58 and the refractive index of the upper air is 1 results in ε₂23.4°.

It can be seen that the light rays distributed in region 2 accounts for 17.2%, and is difficult to be utilized in the conventional design, but the light rays in region 2 in the front light source provided by an embodiment of the present disclosure can be effectively utilized. Thus, the light utilization rate can be significantly improved by 17.2%, and when the front light source is applied to a reflective liquid crystal display panel, the brightness and the contrast of display can be improved, thereby improving the display effect and the use experience of a user.

In some embodiments, as shown in FIGS. 4 and 5, each first microstructure 1031 further has a first inclined surface 1031b connected to the first total internal reflection surface 1031a, and each second microstructure 1032 further has a second inclined surface 1032b connected to the second total internal reflection surface 1032a. Each of an angle δ₁ between the first inclined surface 1031b and the vertical direction and an angle δ₂ between the second inclined surface 1032b and the vertical direction is less than the critical angle θ at which the light is totally internally reflected.

The angle between the first inclined surface 1031b of each first microstructure 1031 and the vertical direction is δ₁, so as to avoid total internal reflection of light in the microstructure layer 103 from being damaged, where δ₁<θ, and calculation according to that the refractive index of the microstructure layer 103 is 1.58 and the refractive index of the upper air is 1 results in δ₁<39.3°. Similarly, the angle between the second inclined surface 1032b of each second microstructure 1032 and the vertical direction is δ₂, so as to avoid the total internal reflection of light in the microstructure layer 103 from being damaged, where δ₂<θ, and calculation according to that the refractive index of the microstructure layer 103 is 1.58 and the refractive index of the upper air is 1 results in δ₂<39.3°.

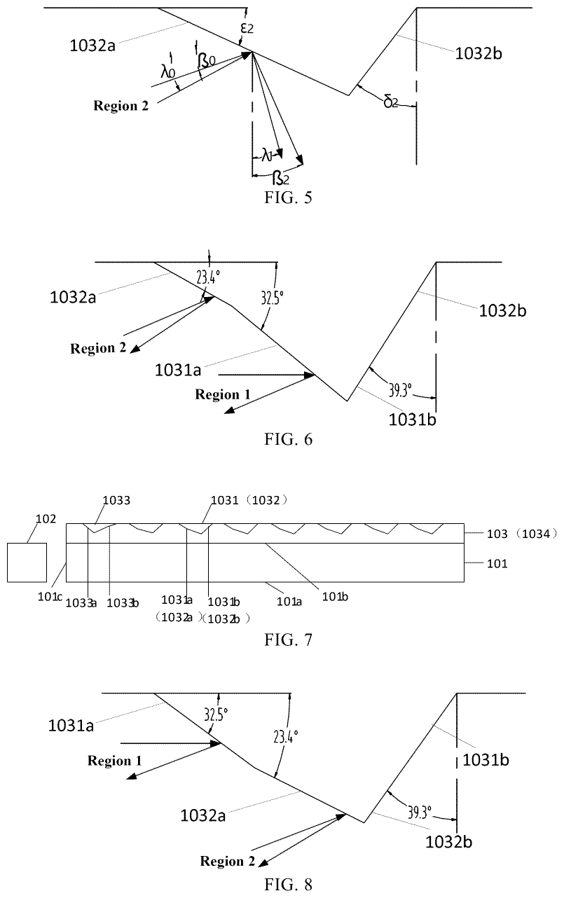

In some embodiments, FIG. 6 is a schematic diagram illustrating a layout of a first microstructure and a second microstructure of the front light source shown in FIG. 3. As shown in FIG. 6, the second microstructure 1032 is located on a side of the first microstructure 1031 distal to the second surface 101b of the light guide layer 101, where the first total internal reflection surface 1031a is connected to the second total internal reflection surface 1032a, and the first inclined surface 1031b is connected to the second inclined surface 1032b.

The first microstructure 1031 and the second microstructure 1032 may be stacked together, where the second microstructure 1032 is located on the side of the first microstructure 1031 distal to the second surface 101b of the light guide layer 101, the first total internal reflection surface 1031a is connected to the second total internal reflection surface 1032a, and the first inclined surface 1031b is connected to the second inclined surface 1032b. The first total internal reflection surface 1031a of the first microstructure 1031 can make the light rays in region 1 be totally internally reflected and extracted out, and the second total internal reflection surface 1032a of the second microstructure 1032 can make the light rays in region 2 be totally internally reflected and extracted out, where the light rays distributed in region 1 accounts for 39.1%, the light rays distributed in region 2 accounts for 17.2%, the light rays in region 2 can also be effectively utilized, and the light utilization rate can reach 39.1%+17.2%=56.3%. As a result, when the extracted light is applied to a reflective liquid crystal display panel, the brightness and the contrast of display can be improved, thereby improving the display effect and the use experience of a user.

In some embodiments, FIG. 7 is a schematic diagram illustrating a structure of another front light source provided by the embodiments of the present disclosure, and FIG. 8 is a schematic diagram illustrating a layout of a first microstructure and a second microstructure of the front light source shown in FIG. 7. As shown in FIG. 7 and FIG. 8, the second microstructure 1032 is located on a side of the first microstructure 1031 proximal to the second surface 101b of the light guide layer 101, where the first total internal reflection surface 1031a is connected to the second total internal reflection surface 1032a, and the first inclined surface 1031b is connected to the second inclined surface 1032b.

The first microstructure 1031 and the second microstructure 1032 may be stacked together, where the second microstructure 1032 is located on the side of the first microstructure 1031 proximal to the second surface 101b of the light guide layer 101, the first total internal reflection surface 1031a is connected to the second total internal reflection surface 1032a, and the first inclined surface 1031b is connected to the second inclined surface 1032b. The first total internal reflection surface 1031a of the first microstructure 1031 can make the light rays in region 1 be totally internally reflected and extracted out, and the second total internal reflection surface 1032a of the second microstructure 1032 can make the light rays in region 2 be totally internally reflected and extracted out, where the light rays in region 1 accounts for 39.1%, the light rays in region 2 accounts for 17.2%, the light rays in region 2 can also be effectively utilized, and the light utilization rate can reach 39.1%+17.2%=56.3%. As a result, when the extracted light is applied to a reflective liquid crystal display panel, the brightness and the contrast of display can be improved, thereby improving the display effect and the use experience of a user.

In some embodiments, as shown in FIGS. 6 and 8, the first microstructures 1031 and the second microstructure 1032 have a one-piece structure.

The first microstructure 1031 and the second microstructure 1032 together may be a groove with a triangular cross section, and have a one-piece structure. In practical applications, the first microstructure 1031 and the second microstructure 1032 may be formed in one step by using an etching process so as to reduce process steps and save manufacturing cost.

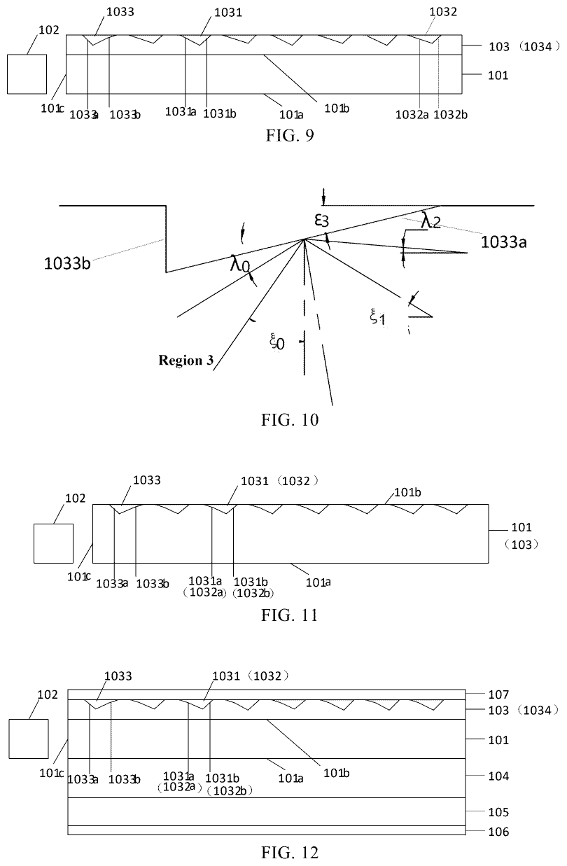

In some embodiments, FIG. 9 is a schematic diagram illustrating a structure of another front light source provided by the embodiments of the present disclosure. As shown in FIG. 9, the first microstructures 1031 and the second microstructures 1032 are alternately arranged to be spaced apart from each other along a direction away from the light source 102.

The first microstructures 1031 and the second microstructures 1032 may be alternately arranged to be spaced apart from each other. Each first microstructure 1031 can make the light rays in region 1 be totally internally reflected and extracted out, and each second microstructure 1032 can make the light rays in region 2 be totally internally reflected and extracted out, where the light rays distributed in region 1 accounts for 39.1%, the light rays distributed in region 2 accounts for 17.2%, the light rays in region 2 can also be effectively utilized, and the light utilization rate can reach 39.1%+17.2%=56.3%. As a result, when the extracted light is applied to a reflective liquid crystal display panel, the brightness and the contrast of display can be improved, thereby improving the display effect and the use experience of a user.

In some embodiments, a distance between any one first microstructure 1031 and the second microstructure 1032 adjacent to the any one first microstructure 1031 is gradually decreased in the direction away from the light source 102.

In the case where the first microstructures 1031 and the second microstructures 1032 are spaced apart from each other, the distance between any one first microstructure 1031 and the second microstructure 1032 adjacent to the any one first microstructure 1031 is gradually decreased in the direction away from the light source 102. On one hand, in a region close to the light source 102, each first microstructure 1031 and each second microstructure 1032 have a strong total internal reflection effect on light, and in order to avoid mutual shielding between a first microstructure 1031 and the second microstructure 1032 adjacent to the first microstructure 1031, the distance between any one first microstructure 1031 and the second microstructure 1032 adjacent to the any one first microstructure 1031 may be set to be larger. In a region away from the light source 102, the distance between any one first microstructure 1031 and the second microstructure 1032 adjacent to the any one first microstructure 1031 may be set to be smaller.

On the other hand, light is reflected for multiple times in the propagation process, and an intensity of the light is subjected to a certain loss. Thus, in the region away from the light source 102, the distance between any one first microstructure 1031 and the second microstructure 1032 adjacent to the any one first microstructure 1031 may be set to be smaller, so as to improve an efficiency of total internal reflection of the light, improve a light extraction efficiency, and ensure the light extraction uniformity, thereby improving the display effect.

It should be noted that in an arrangement of the first microstructures 1031 and the second microstructures 1032, preferably, each second microstructure 1032 is located on the side of a respective first microstructure 1031 distal to the second surface 101b of the light guide layer 101. Because each second microstructure 1032 and a respective first microstructure 1031 are designed to have different angles, the above arrangement can reduce mutual shielding between each first microstructure 1031 and a respective second microstructure 1032, thereby further improving the light utilization rate.

In some embodiments, as shown in FIGS. 3, 7 and 9, the microstructure layer 103 further includes a third microstructure 1033 located between the light source 102 and the first and second microstructures 1031 and 1032. The third microstructure 1033 has a third total internal reflection surface 1033a that totally internally reflects light. The third total internal reflection surface 1033a is disposed opposite to each of the first total internal reflection surface 1031a and the second total internal reflection surface 1032a to reflect the light toward the first total internal reflection surface 1031a and the second total internal reflection surface 1032a.

The third microstructure 1033 may be a groove recessed toward the first surface 101a of the light guide layer 101, and a cross section of the groove may be a triangle, a trapezoid, or the like.

If a light ray close to the light source 102 directly irradiates on the first total internal reflection surface 1031a of a first microstructure 1031 and the second total internal reflection surface 1032a of a second microstructure 1032, an incident angle of the light ray is less than the total internal reflection angle, and the light ray cannot be totally internally reflected and is directly extracted out, which affects the utilization rate of the light. In the structure shown in each of FIG. 3, FIG. 7 and FIG. 9, the third total internal reflection surface 1033a of the third microstructure 1033 may be disposed opposite to the first total internal reflection surface 1031a and the second total internal reflection surface 1032a, to reflect the light rays in region 3 toward the first total internal reflection surface 1031a and the second total internal reflection surface 1032a, so as to effectively utilize the light. The light rays distributed in region 1 accounts for 39.1%, the light rays distributed in region 2 accounts for 17.2%, the light rays distributed in region 3 accounts for 31.3%, the light rays distributed in regions 1, 2, and 3 can be effectively utilized, and the light utilization rate can reach 39.1%+17.2%+31.3%=87.6%. As a result, when the extracted light is applied to a reflective liquid crystal display panel, the brightness and the contrast of display can be improved, thereby improving the display effect and the use experience of a user.

FIG. 10 is a schematic diagram illustrating light paths of the third microstructure of a front light source according to an embodiment of the present disclosure. As shown in FIG. 10, in the third microstructure 1033, an angle between a second boundary incident light ray and the vertical direction is ξ₀, and an angle between a second boundary outgoing light ray and the horizontal direction is ξ₁, where ξ₀=θ, calculation according to that the refractive index of the microstructure layer 103 is 1.58 and the refractive index of the upper air is 1 results in ξ₀=39.30; ξ₁=ξ₀, and calculation according to that the refractive index of the microstructure layer 103 is 1.58 and the refractive index of the upper air is 1 results in ξ₁=27.3°. An angle between the third total internal reflection surface 1033a of the third microstructure 1033 and the horizontal direction is ε₃, where ε₃=(90°−ξ₁+ξ₀)/2−ξ₀, and calculation according to that the refractive index of the microstructure layer 103 is 1.58 and the refractive index of the upper air is 1 results in ε₃=11.7°. An angle between a first boundary incident light ray and the horizontal direction is λ₀, and an angle between a first boundary outgoing light ray and the horizontal direction is λ₂; according to the foregoing section, calculation according to that the refractive index of the microstructure layer is 1.58 and the refractive index of the upper air is 1 results in λ₀=27.30; λ₂=ξ₁−(90°−ξ₀−λ₀), and calculation according to that the refractive index of the microstructure layer is 1.58 and the refractive index of the upper air is 1 results in λ₂=3.9°.

In some embodiments, the third microstructure 1033 further has a third inclined surface 1033b connected to the third total internal reflection surface 1033a, and an angle δ₃ between the third inclined surface 1033b and the vertical direction is smaller than the critical angle θ for total internal reflection of light.

The angle between the third inclined surface 1033b of the third microstructure 1033 and the vertical direction is δ₃, such that total internal reflection of light in the microstructure layer 103 is prevented from being damaged, where δ₃<θ, and calculation according to that the refractive index of the microstructure layer 103 is 1.58 and the refractive index of the upper air is 1 results in δ₃<39.3°.

In some embodiments, the microstructure layer 103 further includes a transparent material filled in each of the first, second, and third microstructures 1031, 1032, and 1033, and a refractive index of the transparent material is less than a refractive index of the light guide layer 101.

The transparent material may be filled in each of the first microstructures 1031, the second microstructures 1032 and the third microstructure 1033, and the refractive index of the transparent material is less than the refractive index of the light guide layer 101. As such, while guaranteeing the total internal reflection of light, the second surface of the microstructure layer 103 can be planarized to be beneficial to being attached to another layer.

In some embodiments, the microstructure layer 103 further includes a support structure 1034 for supporting the first microstructures 1031, the second microstructures 1032 and the third microstructure 1033. The support structure 1034 is located on a side of the second surface 101b of the light guide layer 101, and a refractive index of the support structure 1034 is the same as the refractive index of the light guide layer 101.

The microstructure layer 103 and the light guide layer 101 are formed by different films, and the support structure 1034 is adopted to carry the first microstructures 1031, the second microstructures 1032 and the third microstructure 1033, so as to avoid damage to the light guide layer 101.

In some embodiments, FIG. 11 is a schematic diagram illustrating a structure of another front light source provided by the embodiments of the present disclosure. As shown in FIG. 11, the first microstructures 1031, the second microstructures 1032 and the third microstructure 1033 are formed on the second surface 101b of the light guide layer 101.

The first microstructures 1031, the second microstructures 1032, and the third microstructure 1033 in the microstructure layer 103 may be directly etched and formed on the second surface 101b of the light guide layer 101. In this way, it may not be necessary to actually provide the microstructure layer 103 and the support structure 1034, so as to reduce a thickness of the front light source, which facilitates the lightweight and the thinness of a product.

In a second aspect, an embodiment of the present disclosure provides a display assembly, and FIG. 12 is a schematic diagram illustrating a structure of the display assembly according to the present embodiment. As shown in FIG. 12, the display assembly includes the front light source according to any one of the foregoing embodiments of the present disclosure. The display assembly further includes a polarizer 104, a display panel 105, a reflective layer 106, and a scatterer layer 107. The display panel 105 is located on a side of the first surface 101a of the light guide layer 101, and the reflective layer 106 is located on a side of the display panel 105 distal to the light guide layer 101. The polarizer 104 is located between the display panel 105 and the light guide layer 101, and the scatterer layer 107 is located on a side of the microstructure layer 103 distal to the light guide layer 101.

The display panel 105 may be a liquid crystal display panel, and the reflective layer 106 is attached to the side of the display panel 105 distal to the light guide layer 101. The reflective layer 106 can reflect ambient light to implement reflective display. The polarizer 104 can convert ambient light into polarized light to be irradiated on a liquid crystal layer of the display panel 105. It will be appreciated that the reflective layer 106 may alternatively be arranged inside the display panel, and for example, arranged on a side of the liquid crystal layer distal to the ambient light. The scatterer layer 107 may scatter light that will enter into a user's visual field to change a propagation direction of the light such that the total internal reflection light is converted into diffused reflection light, thereby enlarging a display visual field and realizing display with a large viewing angle. Meanwhile, it may not be necessary to form the scatterer layer 107 on the polarizer 104 to avoid influence on the ambient light, thereby avoiding influence on the total internal reflection of light in the light guide layer 101.

In a third aspect, an embodiment of the present disclosure provides a display device, which includes the display assembly according to any one of the foregoing embodiments. The display device may be any product or component with a reflective display function, such as an intelligent wearable device, a digital photo frame, a navigator, or the like. The implementation principle of the display device is similar to those of the display assembly and the front light source as described above, and detailed description thereof is omitted here.

It will be understood that the above embodiments are merely exemplary embodiments employed to illustrate the principles of the present disclosure, and the present disclosure is not limited thereto. It will be apparent to one of ordinary in the art that various changes and modifications may be made therein without departing from the spirit and scope of the present disclosure, and such changes and modifications are to be considered to fall within the scope of the present disclosure.

1. A front light source, comprising: a light guide layer, a light source, and a microstructure layer, wherein the light guide layer has a first surface and a second surface which are opposite to each other, and a lateral surface connecting the first surface with the second surface, the light source is positioned on a side of the lateral surface of the light guide layer, and the microstructure layer is positioned on a side of the second surface of the light guide layer; and
the microstructure layer comprises a plurality of first microstructures and a plurality of second microstructures, each of the plurality of first microstructures has a first total internal reflection surface for totally internally reflecting light, each of the plurality of second microstructures has a second total internal reflection surface for totally internally reflecting the light, and an angle between the first total internal reflection surface and a horizontal direction is different from an angle between the second total internal reflection surface and the horizontal direction, to cause light rays with different incident angles to be reflected toward the first surface of the light guide layer and extracted out.

2. The front light source according to claim 1, wherein
θ=arcsin(sin 90°×n₁/n₀);
β₀=(90°−α₀+α₁)/2−θ;
β₁=α₁−(β₀−α₀);
ε₁=90°−θ−β₀;
λ₀=(90°−β₀+β₂)/2−−θ+β₀;
λ₁=β₂−(λ₀-31 β₀);
ε₂=(90°−β₀+β₂)/2−β₂;
where θ is a critical angle at which the light undergoes total internal reflection in the microstructure layer, n₁ is a refractive index of the microstructure layer, and n₀ is a refractive index of a structure, which is located on a side of the microstructure layer distal to the light guide layer and is in contact with the microstructure layer;
α₀ is an angle between a first boundary incident light ray in each first microstructure and the horizontal direction, α₁ is an angle between a first boundary outgoing light ray in each first microstructure and a vertical direction, β₀ is each of an angle between a second boundary incident light ray in each first microstructure and the horizontal direction and an angle between a first boundary incident light ray in each second microstructure and the horizontal direction, β₁ is an angle between a second boundary outgoing light ray in each first microstructure and the vertical direction, and ε₁ is an angle between the first total internal reflection surface of each first microstructure and the horizontal direction; and
β₂ is an angle between a first boundary outgoing light ray in each second microstructure and the vertical direction, λ₀ is an angle between a second boundary incident light ray in each second microstructure and the horizontal direction, λ₁ is an angle between a second boundary outgoing light ray in each second microstructure and the vertical direction, and ε₂ is an angle between the second total internal reflection surface of each second microstructure and the horizontal direction.

3. The front light source according to claim 2, wherein each first microstructure further has a first inclined surface connected to the first total internal reflection surface, each second microstructure further has a second inclined surface connected to the second total internal reflection surface, and each of an angle between the first inclined surface and the vertical direction and an angle between the second inclined surface and the vertical direction is less than the critical angle at which the light undergoes total internal reflection.

4. The front light source according to claim 3, wherein each second microstructure is located on a side of a respective first microstructure distal to the second surface of the light guide layer, the first total internal reflection surface is connected to the second total internal reflection surface, and the first inclined surface is connected to the second inclined surface.

5. The front light source according to claim 3, wherein each second microstructure is located on a side of a respective first microstructure proximal to the second surface of the light guide layer, the first total internal reflection surface is connected to the second total internal reflection surface, and the first inclined surface is connected to the second inclined surface.

6. The front light source according to claim 4, wherein each first microstructure and a respective second microstructure have a one-piece structure.

7. The front light source according to claim 3, wherein the first microstructures and the second microstructures are alternately arranged to be spaced apart from each other along a direction away from the light source.

8. The front light source according to claim 7, wherein a distance between any one first microstructure and the second microstructure adjacent to the any one first microstructure is gradually decreased in the direction away from the light source.

9. The front light source according to claim 2, wherein the microstructure layer further comprises a third microstructure located between the light source and the first and second microstructures, the third microstructure has a third total internal reflection surface for totally internally reflecting the light, and the third total internal reflection surface is arranged opposite to each of the first total internal reflection surface and the second total internal reflection surface, so as to reflect the light rays toward the first total internal reflection surface and the second total internal reflection surface.

10. The front light source according to claim 9, wherein ξ₀=θ;
ξ₁=ξ₀;
ε₃=(90°−ξ₁+ξ₀)/2−ξ₀;
λ₂=ξ₁−(90°−ξ₀−λ₀);
where ξ₀ is an angle between a second boundary incident light ray and the vertical direction, ξ₁ is an angle between a second boundary outgoing light ray and the horizontal direction, and ε₃ is an angle between the third total internal reflection surface of the third microstructure and the horizontal direction.

11. The front light source according to claim 10, wherein the third microstructure further has a third inclined surface connected to the third total internal reflection surface, and an angle between the third inclined surface and the vertical direction is less than the critical angle at which the light undergoes total internal reflection.

12. The front light source according to claim 9, wherein each of the first microstructures, the second microstructures, and the third microstructure is a groove recessed toward the first surface of the light guide layer.

13. The front light source according to claim 12, wherein the microstructure layer further comprises a transparent material filled in the first microstructures, the second microstructures, and the third microstructure; and
a refractive index of the transparent material is less than a refractive index of the light guide layer.

14. The front light source according to claim 12, wherein the microstructure layer further comprises a support structure for supporting the first microstructures, the second microstructures, and the third microstructure; and
the support structure is located on the side of the second surface of the light guide layer, and a refractive index of the support structure is the same as a refractive index of the light guide layer.

15. The front light source according to claim 12, wherein the first microstructures, the second microstructures, and the third microstructure are formed on the second surface of the light guide layer.

16. A display assembly, comprising the front light source according to claim 1.

17. The display assembly according to claim 16, further comprising a polarizer, a display panel, a reflective layer, and a scatterer layer;
wherein the display panel is positioned on a side of the first surface of the light guide layer;
the reflective layer is positioned on a side of the display panel distal to the light guide layer;
the polarizer is positioned between the display panel and the light guide layer; and
the scatterer layer is positioned on a side of the microstructure layer distal to the light guide layer.

18. A display device, comprising the display assembly according to claim 16.

19. The front light source according to claim 1, wherein each first microstructure further has a first inclined surface connected to the first total internal reflection surface, each second microstructure further has a second inclined surface connected to the second total internal reflection surface, and each of an angle between the first inclined surface and the vertical direction and an angle between the second inclined surface and the vertical direction is less than the critical angle at which the light undergoes total internal reflection; and
wherein each second microstructure is located on a side of a respective first microstructure distal to or proximal to the second surface of the light guide layer, the first total internal reflection surface is connected to the second total internal reflection surface, and the first inclined surface is connected to the second inclined surface.

20. The front light source according to claim 1, wherein the microstructure layer further comprises a third microstructure located between the light source and the first and second microstructures, the third microstructure has a third total internal reflection surface for totally internally reflecting the light, and the third total internal reflection surface is arranged opposite to each of the first total internal reflection surface and the second total internal reflection surface, so as to reflect the light rays toward the first total internal reflection surface and the second total internal reflection surface.
